(19) United States
(12) Patent Application Publication
(10) Pub. No.: US 2013/0225097 A1
(43) Pub. Date: Aug. 29, 2013

(54) METHOD FOR CANCELLING INTERMODULATION NOISE SIGNAL BETWEEN ANTENNAS AND COMMUNICATION TERMINAL APPARATUS

(71) Applicant: Pantech Co., Ltd., (US)

(72) Inventor: Seok Jin HONG, Seoul (KR)

(73) Assignee: Pantech Co., Ltd., Seoul (KR)

(21) Appl. No.: 13/779,194

(22) Filed: Feb. 27, 2013

(30) Foreign Application Priority Data
Feb. 29, 2012 (KR) 10-2012-0021386

(51) Int. Cl. H04B 15/00

(52) U.S. Cl. CPC H04B 15/00
USPC 455/77; 455/73

(57) ABSTRACT

A communication terminal apparatus and method for performing wireless communication, including a first channel including a first antenna to transmit a first signal at a first frequency, a second channel including a second antenna to receive or transmit one or more second signals at a frequency other than the first frequency of the first signal, and a feedback circuit unit to selectively generate a feedback signal to the second channel to reduce a noise signal from the first signal among the one or more second signals received or transmitted through the second channel. The feedback circuit unit may include a coupler to segment and transfer at least a portion of the first signal, a filter unit to transmit a frequency signal, a phase converter to modulate a phase of the signal transmitted through the filter, and a gain control amplifier to amplify the phase-modulated signal.

### CROSS-REFERENCE TO RELATED APPLICATION

This application claims priority from and the benefit of Korean Patent Application No. 10-2012-0021386, filed on Feb. 29, 2012, which is hereby incorporated by reference for all purposes as if fully set forth herein.

### BACKGROUND

1. Field

Exemplary embodiments relate to a method for cancelling, reducing or minimizing an intermodulation noise signal between antennas.

2. Discussion of the Background

Since wireless data transmission using a communication terminal is generalized, communication terminals, such as handheld, portable or tablet computer or communication devices typically may include a plurality of antennas to transmit and receive signals of different frequencies, simultaneously.

However, among the plurality of antennas, when a signal transmitted by an antenna A is received by an antenna B and acts as a noise signal, or when the signal transmitted by the antenna A is combined with a transmitting signal of the antenna B and intermodulation occurs, a communication quality of the antenna B may be degraded.

For example, when data transmission is performed while performing a voice call using a communication terminal, a data transmitting signal may be received by a voice channel, and noise may be generated. In particular, intermodulation noise may be generated, and such noise may cause degradation in a communication quality.

Among known technologies for preventing deterioration in a communication quality resulting from the intermodulation noise, a Simultaneous Voice and Long Term Evolution (SVLTE) service has been employed. In the conventional SVLTE service, in order to resolve the intermodulation in simultaneous signal transmission of antennas, the strength of a long term evolution (LTE) transmitting signal, corresponding to a data signal, may be decreased uniformly, based on the strength of a Code Division Multiple Access (CDMA) 1X transmitting signal corresponding to a voice call signal.

Also, in the conventional technology, a predetermined look-up table (LUT) may be used to adjust the strength of the LTE transmitting signal based on a level of the strength of the CDMA 1X transmitting signal. When a distance from a base station is relatively great, or the strength of the CDMA 1X transmitting signal is relatively great since a voice call is being performed, a scheme of decreasing the strength of the LTE transmitting signal corresponding to a data communication transmitting signal may be used.

However, decreasing the strength of the LTE transmitting signal may be an indirect or a disadvantageous resolution in that decreasing a quality of a data communication to a predetermined level may be improper for a voice call.

In addition, since a strength of a noise signal may change continuously, such as depending on a peripheral environment and/or a manner of a user gripping a communication terminal, as well as that noise generated in the CDMA 1X channel may be caused by the LTE transmitting signal, the foregoing factors are to be taken into consideration.

### SUMMARY

Exemplary embodiments of the present invention provide a method and apparatus for performing wireless communication at different frequencies for cancellation, reduction or minimization of noise generated as a result of signal transmission and reception.

Additional features of the invention will be set forth in the description which follows, and in part will be apparent from the description, or may be learned by practice of the invention.

Exemplary embodiments of the invention provide a communication terminal apparatus to perform wireless communication, including a first channel including a first antenna to transmit a first signal at a first frequency, a second channel including a second antenna to receive or transmit one or more second signals at a frequency other than the first frequency of the first signal, and a feedback circuit unit to selectively generate a feedback signal to the second channel to reduce a noise signal from the first signal among the one or more second signals received or transmitted through the second channel.

Exemplary embodiments of the invention further provide a method for reducing a noise signal generated by a communication terminal apparatus for performing wireless communication, including transmitting over a first channel of the communication terminal apparatus a first signal at a first frequency, receiving or transmitting over a second channel of the communication terminal apparatus one or more second signals at a frequency other than the first frequency of the first signal, and selectively generating a feedback signal to reduce a noise signal from the first signal among the one or more second signals received or transmitted through the second channel.

Additionally, exemplary embodiments of the invention provide a non-transitory computer-readable media, the media including program instructions that, when executed implement a method embodied by a communication terminal apparatus for reducing a noise signal generated for performing wireless communication, the method including transmitting over a first channel of the communication terminal apparatus a first signal at a first frequency, receiving or transmitting over a second channel of the communication terminal apparatus one or more second signals at a frequency other than the first frequency of the first signal, and selectively generating a feedback signal to reduce a noise signal from the first signal among the one or more second signals received or transmitted through the second channel.

Also, in the exemplary embodiments of the method and communication terminal apparatus, the first signal may include a data signal and the one or more second signals may include a voice signal, and the noise signal may include intermodulation noise and the feedback signal may include an inverse phase signal of the first signal.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a communication terminal apparatus according to exemplary embodiments of the present invention.

FIG. 2 is a block diagram illustrating a communication terminal apparatus according to exemplary embodiments of the present invention.

FIG. 3 is a flowchart illustrating a method for cancelling, reducing or minimizing intermodulation noise according to exemplary embodiments of the present invention.

FIG. 4 is a flowchart illustrating a method for cancelling, reducing or minimizing intermodulation noise according to exemplary embodiments of the present invention.

FIG. 5 is a flowchart illustrating a detailed operation for cancelling, reducing or minimizing intermodulation noise according to exemplary embodiments of the present invention.

FIG. 6 is a flowchart illustrating a process for performing cancellation, reduction or minimization of intermodulation noise according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present.

Hereinafter a communication terminal apparatus or communication terminal, such as including, for example, handheld, portable or tablet computer or communication devices, and a method for cancelling, reducing or minimizing noise or a noise signal generated by a communication terminal apparatus will be described in more detail with reference to the drawings. Also, cancelling, reducing or minimizing noise or a noise signal may be used interchangeably, one for the other, and should not be construed in a limiting sense.

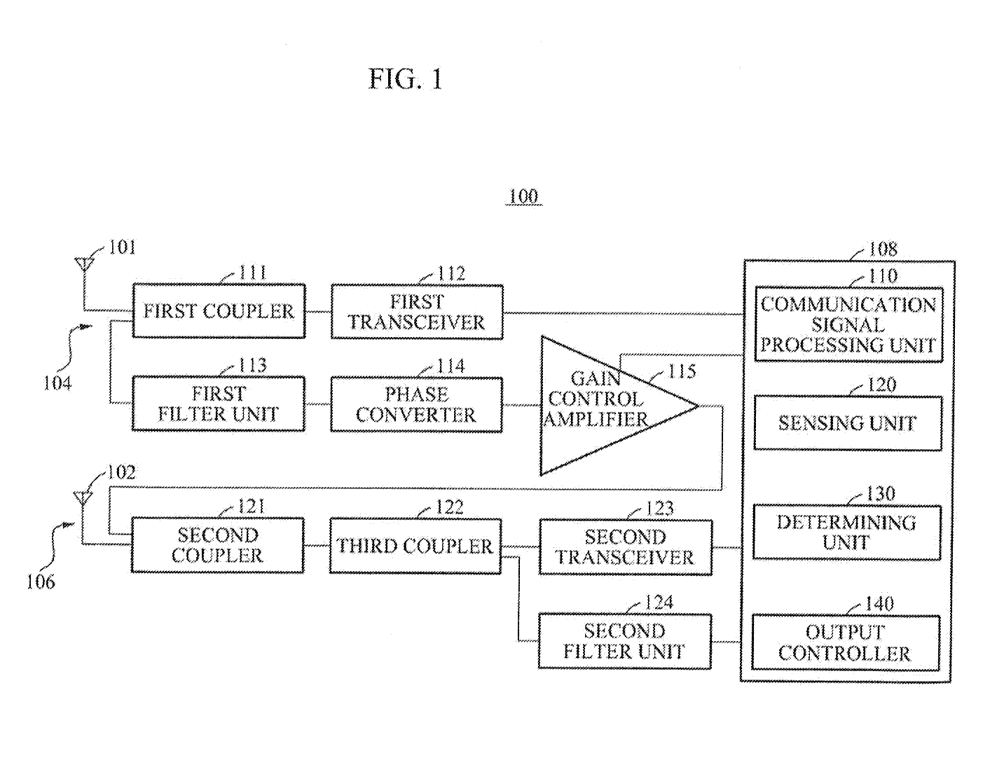

FIG. 1 is a block diagram illustrating a communication terminal apparatus 100 according to exemplary embodiments of the present invention.

Referring to FIG. 1, the communication terminal apparatus 100 may perform a data communication using a first transceiver 112 and a first antenna 101. The communication terminal apparatus 100 may include a first channel 104 including the first antenna 101 to transmit a first signal, such as a data signal, at a first frequency. The data communication may include, for example, a data communication using a Long Term Evolution (LTE) scheme.

However, the data communication may not be limited thereto. The data communication may include a data communication using any other schemes, for example, a Code Division Multiple Access (CDMA) Evolution-Data Optimized (EV-DO), a wireless fidelity (WiFi), a wireless broadband (WiBro), and the like. Accordingly, unless otherwise mentioned hereinafter, the data communication should not be construed as being limited to a specific scheme.

The communication terminal apparatus 100 may perform a communication for a voice call, using a second transceiver 123, and a second antenna 102. The communication terminal apparatus 100 may include a second channel 106 including the second antenna 102 to receive or transmit one or more second signals, such as including voice signals, at a frequency other than the first frequency of the first signal. For example, the communication for the voice call may include a communication using a CDMA 1X scheme or may include a communication using an LTE network, as well as other suitable communication networks or schemes, and, therefore, should not be construed in a limiting sense.

However, the communication using the second transceiver 123 and the second antenna 102 may not be limited to a communication for a voice call, and may be construed as a reference communication scheme that may be performed in a separate frequency band, separately from the communication using the first transceiver 112, and the first antenna 101.

Accordingly, for a case in which intermodulation noise may be generated when a signal transmitted by the first transceiver 112 through the first antenna 101 is received by the second transceiver 123 through the second antenna 102, a noise cancelling, reducing or minimizing scheme according to an exemplary embodiment of the present invention may be applied, irrespective of a communication scheme.

The communication control apparatus 100 includes a control unit 108. The control unit 108 includes any of various memory or storage media for storing software, program instructions, data files, data structures, and the like, and the control unit 108 also includes any of various processors, computers or application specific integrated circuits (ASICs) for example, to implement various operations in cancelling, reducing or minimizing generated noise or noise signals, as described herein. The software, media and program instructions may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described embodiments of the present invention.

Also, the control unit 108 may include the following units, controllers or elements, which may perform one or more of the described functions and operations to perform noise cancellation, reduction or minimization, according to exemplary embodiments. Also, the units, processors or elements of the control unit 108 may be combined in performing the various described functions and operations. As further described herein, the control unit 108 may include a communication signal processing unit 110, a sensing unit 120, a determining unit 130 and an output controller 140.

The communication signal processing unit 110 may control processing of the first signal and the one or more second signals by the communication terminal apparatus 100.

The sensing unit 120 may determine one or more of the strength of the first signal, the strength of the one or more second signals, the level of noise of the noise signal, the SNR of the one or more second signals of the second channel 106, and an idle state or an active state of the first channel 104 and the second channel 106 relative to transmission or reception of the first signal and the one or more second signals.

The determining unit 130 may compare at least one predetermined or reference threshold value to at least one of the strength the first signal, to the level of noise of the noise signal or to the SNR of the one or more second signals, and may determine whether a noise signal from the first signal among the one or more second signals received or transmitted through the second channel 106 has been cancelled, reduced or minimized, and may determine an adjusted strength of the first signal based on one or more of a strength of transmitted one or more second signals or based on a sum of the strength of the first signal and the strength of the transmitted one or more second signals.

The output controller 140 may selectively adjust the strength of the first signal, selectively adjust the gain of a feedback signal for cancelling, reducing or minimizing the noise signal by generating a control signal, or may selectively enable generation of the feedback signal, based on the result of the comparison by or the determination of the determining unit 130.

A communication signal processing unit 110 of the communication terminal apparatus 100 may refer to a block representing a communication signal processing module to process the data communication through the first transceiver 112, the voice call through the second transceiver 123, and the like.

A first coupler 111 may segment at least a portion of the first signal transmitted by the first channel 104, such as a data transmitting signal, transmitted by the first transceiver 112, and may transfer the segmented signal to a first filter unit 113. Accordingly, the first filter unit 113 may receive an input of a signal identical to the signal transmitted through the first antenna 101.

The first filter unit 113 may filter the segmented first signal to generate a filtered frequency signal corresponding to the first signal. The first filter unit 113 may transmit, to a phase converter 114, a signal corresponding to a frequency of the data communication of the first transceiver 112, among signals transferred through the first coupler 111.

The phase converter 113 may convert a phase of the filtered signal transferred from the first filter unit 113, and may transfer the phase-converted signal to a gain control amplifier 115. The phase converter 113 may modulate a phase of the filtered frequency signal corresponding to the first signal to generate a phase modulated signal for cancelling, reducing or minimizing the noise signal resulting from transmission of the first signal.

The gain control amplifier 115 may amplify the transferred signal based on the control signal from the control unit 108 to cancel, reduce or minimize the noise signal received through the second channel 106, and may transfer the amplified signal to a second coupler 121. The gain control amplifier 115 may selectively adjust, such as by increasing, maintaining or reducing, a gain of the phase-modulated signal to generate the feedback signal for cancelling, reducing or minimizing the noise signal received through the second channel 106.

A feedback circuit unit of the communication terminal apparatus 100 may include, for example, one or more of the first filter unit 113, the phase converter 114 and the gain control amplifier 115, and may include other components of the communication terminal apparatus 100, as described herein, to selectively generate the feedback signal to the second channel 106 to cancel, reduce or minimize the noise signal from the first signal among the one or more second signals received or transmitted through the second channel 106.

The second coupler 121 may couple a signal received from the second antenna 102 to an inverse phase signal transferred from the gain control amplifier 115, and may transfer the coupled signal to a third coupler 122. The second coupler 121 may couple the gain adjusted phase modulated feedback signal from the gain control amplifier 115 to the one or more second signals received by the second channel 106 for cancelling, reducing or minimizing the noise signal received through the second channel 106. Here, the one or more second signals received from the second antenna 102 may include a portion of the signals transmitted from the first transceiver 112.

The control signal from the control unit 108 may be used to control the gain control amplifier 115 to minimize the strength of a frequency signal, associated with the first transceiver 112, transferred to the second transceiver 123.

The signal output from the gain control amplifier 115, that is, the inverse phase signal, may have an identical or substantially identical strength to the signal transmitted from the first transceiver 112, but, however, may have an opposite phase to the signal transmitted from the first transceiver 112. Accordingly, the inverse signal may correspond to a signal to be used for cancelling, reducing or minimizing the frequency signal associated with the first transceiver 112 from the signals received through the second antenna 102.

Through the foregoing process, a signal in a frequency band associated with the first transceiver 112 may be cancelled from, reduced or minimized in the one or more second signals transferred to the second transceiver 123, and an occurrence of noise or a noise signal, such as intermodulation noise between channels, such as the first channel 104 and the second channel 106, may be minimized.

Accordingly, intermodulation noise occurring between channels 104 and 106 may be cancelled, reduced or minimized actively, such as during active signal transmission and reception. However, since the cancellation, reduction or minimization of the intermodulation noise or noise signal may be performed in an incomplete manner due to a manner of a user gripping the communication terminal apparatus 100, or as a result of a change in a peripheral radio wave environment, a feedback process of re-adjusting the gain by detecting, in real time, a signal output by the first transceiver 112, among the signals transferred to the second transceiver 123, may be employed, according to an exemplary embodiment of the present invention.

Through the feedback process, the third coupler 122 may transfer, to the second transceiver 123, the signal transferred by the second coupler 121, and may segment a portion of the signal transferred by the second coupler 121 to transfer the segmented signal to a second filter 124.

The second filter unit 124 may transmit a signal corresponding to a frequency band associated with the first transceiver 112, and the sensing unit 120 may sense a strength of the first signal, associated with the first transceiver 112, output from the second filter unit 124.

The determining unit 130 may determine whether the sensed strength of the first signal is greater than or equal to a predetermined or reference threshold value. When the sensed strength of the first signal is greater than or equal to the predetermined or reference threshold value, the output controller 140 may adjust a gain of the gain control amplifier 115, and may transfer, to the gain control amplifier 115, a control signal to minimize the sensed strength of the first signal.

The control signal may increase or decrease the gain, as each case dictates. In addition, the control signal may be associated with a control to perform the cancellation, reduction, or minimization of the intermodulation noise more efficiently, by controlling the phase converter 114.

Through the feedback process, the cancellation, reduction or minimization of the intermodulation noise or noise signal may be performed adaptively, and the intermodulation noise or noise signal may be cancelled, reduced or minimized efficiently, based on the strength of the transmitted first signal, that is received among the one or more transmitted or received second signals, which may be adaptively changed in real time, and/or in relation to a peripheral environment of the communication terminal apparatus, such as communication terminal apparatus 100.

The process for cancelling, reducing or minimizing the intermodulation noise or noise signal may be performed unconditionally or on a substantially continuous basis during signal transmission and reception by the communication control apparatus 100. The process for cancelling, reducing or minimizing the intermodulation noise or noise signal may be performed selectively when a communication quality, such as a level of noise, associated with the second transceiver 123 is less than or equal to a predetermined level, such as to reduce power consumption, for example.

As an example, when a signal to noise ratio (SNR) in a communication associated with the second transceiver 123 is less than a predetermined or reference first threshold value, the process for cancelling, reducing or minimizing the intermodulation noise or noise signal may be performed. When a communication scheme associated with the second transceiver 123 corresponds to a CDMA 1X communication scheme, the predetermined or reference first threshold value may be set to, for example, 7.4 decibels (dB).

When a quality of a communication associated with the second transceiver 123, for example, a quality of a voice call, is greater than or equal to the predetermined level, the process for cancelling, reducing or minimizing the intermodulation noise or noise signal selectively may not be performed unnecessarily, whereby an amount of power consumed, by the gain control amplifier 115, and the like, for the process for cancelling, reducing or minimizing the intermodulation noise or a noise signal may be reduced. Accordingly, such selective performance for cancelling, reducing or minimizing the intermodulation noise or noise signal may be advantageous in an aspect of power management.

A criterion for determining whether the process of cancelling, reducing or minimizing the intermodulation noise is to be performed may correspond to whether a strength of the first signal, associated with the first transceiver 112, that is received by the second transceiver 123 is greater than or equal to a predetermined or reference second threshold value.

When the strength of the first signal, associated with the first transceiver 112, received by the second transceiver 123 is less than the predetermined or reference second threshold value, although the SNR of the second signal is relatively low, it may be assumed that the low SNR may be attributed to other factors, for example, a peripheral communication environment, and the like, as opposed to the intermodulation noise or a noise signal.

Accordingly, in this instance, the output controller 140 may improve the SNR by increasing the strength of the signal output from the second transceiver 123.

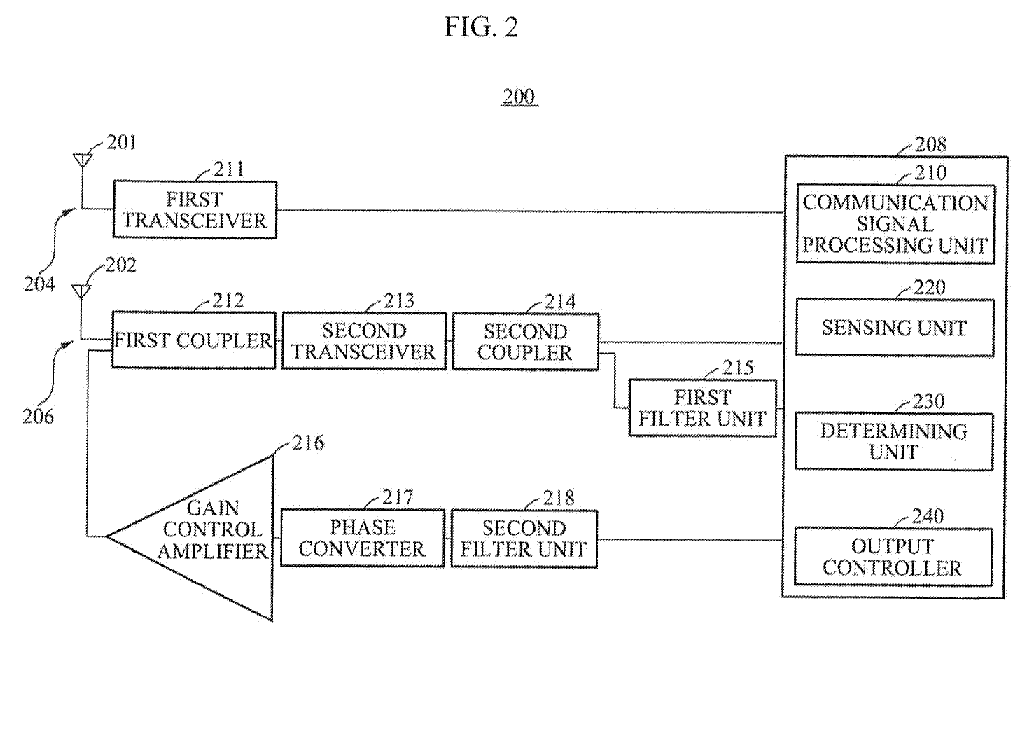

FIG. 2 is a block diagram illustrating a communication terminal apparatus 200 according to exemplary embodiments of the present invention.

In the description provided with reference to FIG. 1, feedback circuits for performing the process for cancelling, reducing or minimizing the intermodulation noise or noise signal, that is, the first filter unit 113, the phase converter 114, and the gain control amplifier 115 may receive, from the first coupler 111, the signal output by the first transceiver 112, directly.

However, such a configuration as may be associated with the communication control apparatus 100 may be unsuitable for the communication terminal apparatus 200, depending on a design being implemented.

Accordingly, in the communication terminal apparatus 200, feedback circuits may be configured in a form of a separate circuit unit, rather than being disposed between a first antenna 201 and a first transceiver 211, or between a second antenna 202 and a second transceiver 213, for example.

Referring to FIG. 2, the communication terminal apparatus 200 may perform a data communication using a first transceiver 211, and a first antenna 201. The communication terminal apparatus 200 may include a first channel 204 including the first antenna 201 to transmit a first signal, such as a data signal, at a first frequency. The data communication may include, for example, a data communication using a Long Term Evolution (LTE) scheme.

However, the data communication by the communication terminal apparatus 200 may not be limited thereto. The data communication may include a data communication using any other schemes, for example, a Code Division Multiple Access (CDMA) Evolution-Data Optimized (EV-DO), a wireless fidelity (WiFi), a wireless broadband (WiBro), and the like. Accordingly, unless otherwise mentioned hereinafter, the data communication should not be construed as being limited to a specific scheme.

The communication terminal apparatus 200 may perform a communication for a voice call, using a second transceiver 213, and a second antenna 202. The communication terminal apparatus 200 may include a second channel 206 including the second antenna 202 to receive or transmit one or more second signals, such as including voice signals, at a frequency other than the first frequency of the first signal. For example, the communication for the voice call may include a communication using a CDMA 1X scheme or may include a communication using an LTE network, as well as other suitable communication networks or schemes, and, therefore, should not be construed in a limiting sense.

However, the communication using the second transceiver 213 and the second antenna 202 may not be limited to a communication for a voice call, and may be construed as a predetermined communication scheme that may be performed in a separate frequency band, separately from the communication using the first transceiver 211, and the first antenna 201.

Accordingly, for a case in which intermodulation noise or noise signal may be generated when a signal transmitted by the first transceiver 211 through the first antenna 201 is received by the second transceiver 213 through the second antenna 202, a noise cancelling, noise reducing or noise minimizing scheme according to an exemplary embodiment of the present invention may be applied, irrespective of a communication scheme.

Similar to the communication control apparatus 100, the communication control apparatus 200 includes a control unit 208. The control unit 208 includes any of various memory or storage media for storing software, program instructions, data files, data structures, and the like, and the control unit 208 also includes any of various processors, computers or application specific integrated circuits (ASICs) for example, to implement various operations in cancelling, reducing or minimizing generated noise or noise signals, as described herein. The software, media and program instructions may be those specially designed and constructed for the purposes of the present invention, or they may be of the kind well-known and available to those having skill in the computer software arts. Examples of program instructions include both machine code, such as produced by a compiler, and files containing higher level code that may be executed by the computer using an interpreter. The described hardware devices may, for example, include hardware, firmware or other modules to perform the operations of the described embodiments of the present invention.

Also, similar to the control unit 108, the control unit 208 may include the following units, controllers or elements, which may perform one or more of the described functions and operations to perform noise cancellation, reduction or minimization, according to exemplary embodiments. Also, the units, processors or elements of the control unit 208 may be combined in performing the various described functions and operations. As further described herein, the control unit 208 may include a communication signal processing unit 210, a sensing unit 220, a determining unit 230 and an output controller 240.

The communication signal processing unit 210 may control processing of the first signal and the one or more second signals by the communication terminal apparatus 200.

The sensing unit 220 may determine one or more of the strength of the first signal, the strength of the one or more second signals, the level of noise of the noise signal, the SNR of the one or more second signals of the second channel 206, and an idle state or an active state of the first channel 204 and the second channel 206 relative to transmission or reception of the first signal and the one or more second signals.

The determining unit 230 may compare at least one predetermined or reference threshold value to at least one of the strength the first signal, to the level of noise of the noise signal or to the SNR of the one or more second signals, and may determine whether a noise signal from the first signal among the one or more second signals received or transmitted through the second channel 206 has been cancelled, reduced or minimized, and may determine an adjusted strength of the first signal based on one or more of a strength of transmitted one or more second signals or based on a sum of the strength of the first signal and the strength of the transmitted one or more second signals.

The output controller 240 may selectively adjust the strength of the first signal, selectively adjust the gain of a feedback signal for cancelling, reducing or minimizing the noise signal by generating a control signal or may selectively enable generation of the feedback signal, based on the result of the comparison by or the determination of the determining unit 230.

In the communication control apparatus 200, when a first signal transmitted by the first transceiver 211 through the first antenna 201 is received through the second antenna 202, at least a portion of the received first signal may be transferred through a first coupler 212, the second transceiver 213, and a second coupler 214, filtered by a first filter unit 215, and transferred directly to a sensing unit 220. The first coupler 212 may segment at least a portion of the first signal transmitted by the first channel 204; and the first filter unit 215 may filter the segmented first signal to generate a filtered frequency signal corresponding to the first signal.

When a signal in a frequency band associated with the first transceiver 211 is transferred through the first filter unit 215 to the sensing unit 220, the determining unit 230 may compare a strength of the transferred first signal to a predetermined or reference second threshold value.

When the determining unit 230 determines that the strength of the first signal is greater than or equal to the predetermined or reference second threshold value, the signal may be transferred to a second filter unit 218 based on a transfer control signal of an output controller 240, and the second filter unit 218 may transfer a frequency signal associated with the first signal from the first transceiver 211 to a phase converter 217.

The phase converter 217 may modulate a phase of the filtered frequency signal corresponding to the first signal to generate a phase modulated signal for cancelling, reducing or minimizing the noise signal resulting from transmission of the first signal. The phase converter 217 may provide the phase modulated signal to a gain control amplifier 216.

The gain control amplifier 216 may selectively adjust a gain of the phase-modulated signal to generate the feedback signal for cancelling, reducing or minimizing the noise signal received through the second channel 206. The control unit 208 may selectively generate a control signal for cancelling, reducing or minimizing the noise signal received through the second channel and the gain control amplifier 216 may selectively adjust the gain of the phase-modulated feedback signal based on the control signal from the control unit 208.

Through the phase converter 217 and a gain control amplifier 216, a signal, having a phase opposite to a phase of the first signal, associated with the first transceiver 211, received by the second transceiver 213, and a strength identical or substantially identical to a strength of the first signal, associated with the first transceiver 211, received by the second transceiver 213, may be transferred to the first coupler 212.

The first signal associated with the first transceiver 211 may be cancelled, reduced or minimized through the first coupler 212, and power consumption required for the first signal associated with the first transceiver 211 to the second transceiver 213 may be minimized. In this regard, the first coupler 212, similar to the second coupler 121, also may couple the gain adjusted phase modulated feedback signal from the gain control amplifier 216 to the one or more second signals received or transmitted by the second channel 206 for cancelling, reducing or minimizing the noise signal received through the second channel 206.

Whether a strength of the first signal in the frequency band associated with the first transceiver 211, among the one or more second signals as may be transferred to the sensing unit 220, is greater than or equal to the predetermined or reference second threshold value may be monitored, such as by the control unit 208. When the strength of the first signal is less than the predetermined or reference second threshold value, the aforementioned process for cancelling, reducing or minimizing noise or a noise signal may not be performed and, as such, additional power consumption by the communication terminal apparatus 200 may be unnecessary.

The aforementioned process for cancelling, reducing or minimizing noise or a noise signal may be understood as a feedback process of cancelling, reducing or minimizing an output frequency band associated with the first signal of the first transceiver 211, as necessary, by feeding back the output frequency band of the first transceiver 211 actively, at ends below the second transceiver 213.

In the communication control apparatus 200, a feedback circuit unit of the communication terminal apparatus 200 may include, for example, one or more of the first filter unit 215, the phase converter 217 and the gain control amplifier 216, any may include other components of the communication terminal apparatus 200, as described herein, to selectively generate the feedback signal to the second channel 206 to cancel, reduce or minimize the noise signal from the first signal among the one or more second signals received or transmitted through the second channel 206.

Accordingly, in the communication control apparatus 200, for example, degradation of a communication quality caused by noise or a noise signal, and the like, generated when a signal output from the first transceiver 211 is received by an end of the second transceiver 213, may be actively removed, reduced or minimized and an appropriate response to quality degradation caused by a change in a peripheral communication environment, signal interference between channels, and the like may be made.

According to an exemplary embodiment of FIG. 2, in the communication terminal apparatus 200, for example, a degree of freedom in implementation of a circuit may be facilitated such that convenience of designing a terminal and/or a circuit may be facilitated, when compared relative to the communication terminal apparatus 100 of the exemplary embodiment of FIG. 1.

Although a process of transferring, to the second filter unit 218, the signal received by the end of the second transceiver 213 may not be shown in the exemplary circuit diagram of FIG. 2, such process of transferring may correspond to a process of transferring the signal to the second filter unit 218, from a predetermined node below an output end of the first coupler 212, for example, an output node of the first coupler 212, an output node of the second transceiver 213, an output node of the second coupler 214, and the like. Accordingly, the process is not to be construed in a limiting sense as being limited to the example of the circuit illustrated in FIG. 2.

In the exemplary embodiment of FIG. 2, as described with reference to FIG. 1, the process for cancelling, reducing or minimizing the intermodulation noise or noise signal through feedback may not be performed unconditionally or on a relatively continuous basis, but instead, may be performed selectively when an SNR of a one or more second signals received or transmitted through the channel 206 associated with the second transceiver 213 is less than a predetermined or reference first threshold value.

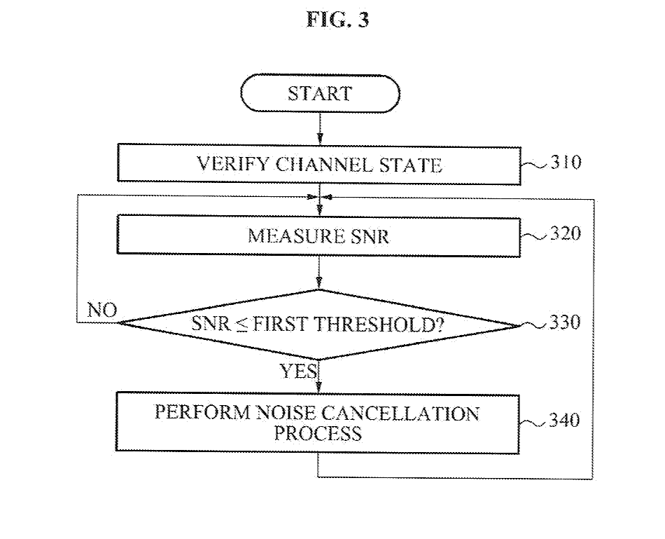

An advantage of reduction in power consumption achieved through the aforementioned process as described with reference to FIG. 2 may be the same as described with reference to FIG. 1. Exemplary embodiments of processes for cancelling, reducing or minimizing the intermodulation noise or noise signal will be described with reference to FIG. 3 and subsequent drawings.

FIG. 3 is a flowchart illustrating a method for cancelling, reducing or minimizing intermodulation noise or a noise signal according to exemplary embodiments of the present invention.

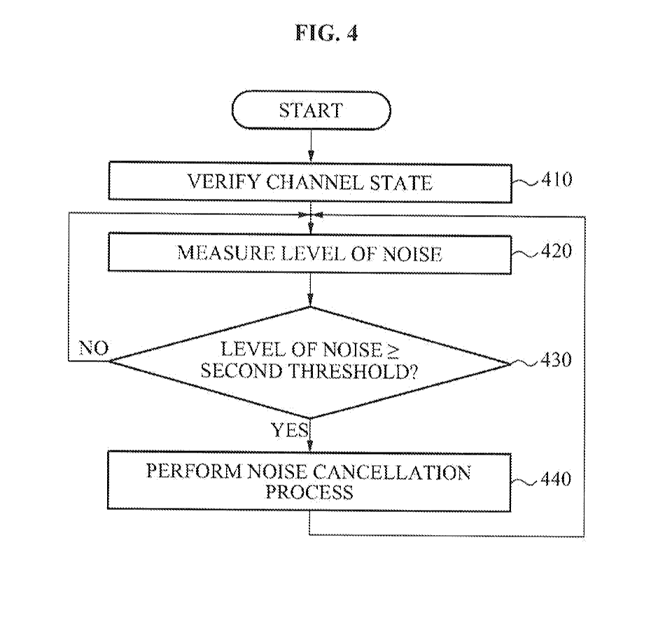

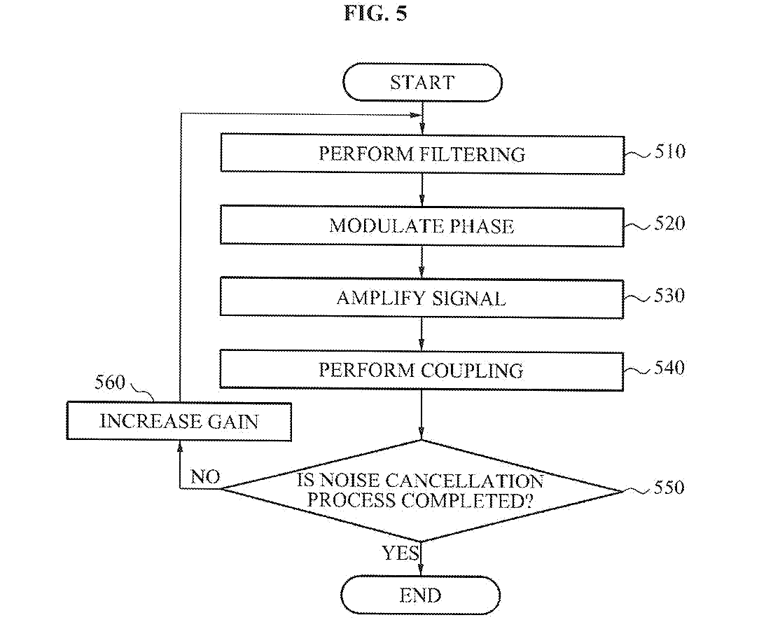

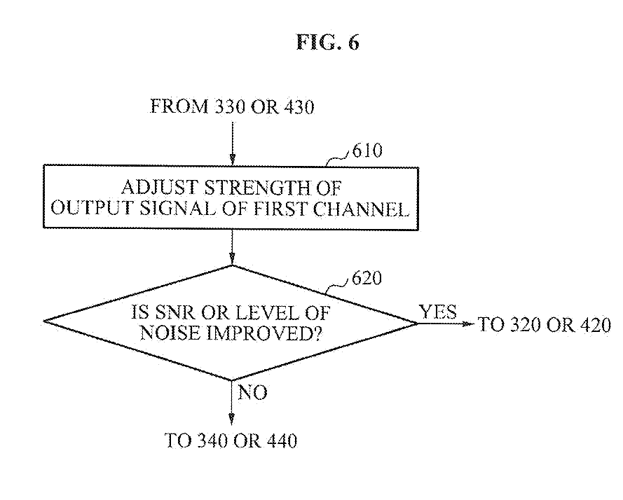

Hereinafter, although the exemplary communication terminal apparatus 100 of FIG. 1 may be used to describe the method of cancelling, reducing or minimizing the intermodulation noise with reference to the flowchart of FIG. 3 and the subsequent flowcharts of FIG. 4, FIG. 5 and FIG. 6, exemplary embodiments to be described through the flowcharts are not limited to the configuration of the communication terminal apparatus 100, but may similarly implemented by the communication terminal apparatus 200 of FIG. 2, or by other equivalent apparatus or circuits.

Accordingly, hereinafter, unless otherwise mentioned, although the method for cancelling, reducing or minimizing the intermodulation noise or a noise signal may be described by referring to the configuration of the exemplary communication terminal apparatus 100, modifications as illustrated in the communication terminal apparatus 200 of FIG. 2, or as in an equivalent communication terminal apparatus or equivalent circuit of another configuration to perform one or more of the described functions, should also be construed as being included within the scope of the present invention and should not be construed in a limiting sense.

Referring to FIG. 3, in operation 310, the sensing unit 120 may verify or determine an idle state or an active state of a first communication channel, such as first channel 104, and an active state or an idle state of a second communication channel, such as second channel 106. Here, the verification or determination of the idle state or the active state of the communication channel may correspond to verifying or determining whether a communication signal is transmitted or received through the first channel 104 associated with the first transceiver 112 and a communication signal is transmitted or received by the second channel 106 associated with the second transceiver 123, simultaneously or relatively at a same time. Idle state and standby state are used interchangeably, one for the other.

The verification or determination of the idle state or active state of the communication channel may be performed to fundamentally determine whether an active and adaptive process for cancelling, reducing or minimizing the intermodulation noise or noise signal is to be performed through a feedback process as described with reference to FIGS. 1 and 2.

That is, intermodulation between channels may not be caused when transmission and reception of a signal is not performed through the first channel 104 and the second channel 106, simultaneously or relatively at a same time as, for example, when only a voice call through the second channel 106 is performed, the second channel thereby being in an active state, while a data communication through the first channel 104 is in an idle, or standby, state of not transmitting or receiving a signal. And, as such, the process of determining whether a signal transmitted from the first channel 104 is received by the second channel 106, or the feedback process may be unnecessary, such as where the first channel 104 is in the idle, or standby, state.

Accordingly, when it is determined that the process for cancelling, reducing or minimizing the intermodulation noise or noise signal is to be performed, in the operation 310, the feedback process may be performed such that power consumption may be minimized.

In operation 320, the sensing unit 120 may measure an SNR of the one or more second signals received or transmitted through the second channel 106.

In operation 330, the determining unit 130 may determine whether the measured SNR is less than a predetermined or reference first threshold value. If not, the process then returns to operation 320. The operation 330 may be performed since a communication quality may not be degraded when the SNR of the one or more second signals received or transmitted through the second channel 106 is greater than or equal to a predetermined or reference level, for example, 7.4 dB in a case of a CDMA 1X communication scheme. And in such case, the process for cancelling, reducing or minimizing the intermodulation noise or noise signal through the feedback may be unnecessary. Accordingly, the overall power consumption of the communication terminal apparatus 100 may be minimized, and power management efficiency may be increased or facilitated.

When the measured SNR is less than the predetermined or reference first threshold value as a result of the operation 330, a process for cancelling, reducing or minimizing the intermodulation noise or noise signal may be performed based on a control signal of the output controller 140, in operation 340. And the process then returns to operation 320.

The process for cancelling, reducing or minimizing the intermodulation noise or noise signal may correspond to a process for cancelling, reducing or minimizing a first signal transmitted from the first channel 104, among one or more second signals received or transmitted through the second channel 106, using the configuration of a feedback circuit unit as, for example, may include the first filter unit 113, the phase converter 114, and the gain control amplifier 115. The process for cancelling, reducing or minimizing the intermodulation noise or noise signal will be described further with reference to FIG. 5.

According to exemplary embodiments of the present invention, the operation 340 may not be performed unconditionally or on a relatively continuous basis, and instead, a process of adjusting the strength of an output first signal of the first channel 104 based on a level of an output signal of the second channel 106 may be performed selectively, in advance. The process of adjusting the strength of an output first signal will be described in detail with reference to FIG. 6.

FIG. 4 is a flowchart illustrating a method for cancelling, reducing or minimizing intermodulation noise or a noise signal according to exemplary embodiments of the present invention.

As described with reference to FIGS. 1 and 2, the process for cancelling, reducing or minimizing the intermodulation noise or noise signal may be performed separately or independently from the process of determining the SNR of the second channel of FIG. 3, when a measured strength of a first signal transmitted from the first channel 104, among one or more second signals received or transmitted by the second channel 106, is greater than or equal to a predetermined or reference second threshold value.

The process described with reference to FIG. 4 may be performed based on an understanding that a low SNR of the one or more second signals of the second channel 106 may be attributed to other factors as, for example, deterioration of a peripheral communication environment, and the like, as opposed to intermodulation noise generated by the first signal transmitted from the first channel 104.

In operation 410, the sensing unit 120 may verify an active state or an idle, or standby, state of a communication channel, such as the first channel 104 and the second channel 106. Here, the verification of the state of the communication channel may correspond to verifying whether a communication signal is output or received through the first channel 104 associated with the first transceiver 112 and a communication signal is received or transmitted through the second channel 106 associated with the second transceiver 123, simultaneously or relatively at a same time.

The verification of the state of the communication channel may be performed to fundamentally determine whether an active and adaptive process for cancelling, reducing or minimizing the intermodulation noise or noise signal is to be performed through a feedback process as described with reference to FIG. 1 and FIG. 2.

In operation 420, when communication is performed through the first channel 104 and the second channel 106, simultaneously or at relatively a same time, the sensing unit 120 may measure a strength of the first signal transmitted from the first channel 104, among the one or more second signals received or transmitted by the second channel 106, that is, a level of noise relative to or from a point of view of the second channel 106.

In operation 430, the determining unit 130 may determine whether the measured level of noise or the noise signal is greater than or equal to a predetermined or reference second threshold value. If not, the process returns to operation 420. When the measured level of noise or the noise signal is greater than or equal to the predetermined or reference second threshold value, the process for cancelling, reducing or minimizing the intermodulation noise or the noise signal may be performed, in operation 440. The process then returns to operation 420.

Similar to the operation 340 of FIG. 3, the operation 440 may correspond to a process for cancelling, reducing or minimizing the first signal transmitted from the first channel 104, among the one or more second signals received or transmitted by the second channel 106, such as by using the configuration of the feedback circuit unit, as described. The operation 440 will be further described in detail with reference to FIG. 5.

Also, as described with reference to FIG. 3, the operation 440 may not be performed unconditionally or on a relatively continuous basis, and instead, a process of adjusting the strength of an output signal of the first channel based on a level of an output signal of the second channel may be performed selectively, in advance. Such adjusting process may be further described in detail with reference to FIG. 6.

FIG. 5 is a flowchart illustrating an exemplary detailed operation 340 of FIG. 3 or of operation 440 of FIG. 4 for cancelling, reducing or minimizing intermodulation noise or a noise signal according to exemplary embodiments of the present invention.

Referring to FIG. 5, in operation 510, the first filter unit 113 may receive a portion of an output first signal of the first transceiver 112 from the first coupler 111, and may filter a frequency band of the first signal from the first channel 104 to provide the filtered frequency signal to the phase converter 114.

In operation 520, the phase converter 114 may modulate a phase of the transferred filtered frequency signal. In operation 530, a phase modulated signal having a phase opposite to a phase of the first signal transmitted from the first channel 104 may be provided to the gain control amplifier 115 to amplify the phase modulated signal, as described.

As described with reference to FIG. 1 or FIG. 2, the operation 520 and the operation 530 may be performed in order to generate a signal having a phase opposite to a phase of the first signal transmitted from the first channel 104, and a strength identical or substantially identical to a strength of the first signal transmitted from the first channel 104, among the one or more second signals received or transmitted by the second channel 106.

In operation 540, the second coupler 121 may couple the inverse phase signal amplified in operation 530 to the first signal and the one or more second signals received or transmitted through the second antenna 102, and may transfer the coupled signal to the third coupler 122 and the second transceiver 123.

In operation 550, the determining unit 130 may determine whether the noise cancellation, reduction or minimization process is completed through the operations 510 through 540. If so, the process proceeds to End.

A criterion for determining whether the noise cancellation, reduction or minimization process is completed may correspond to whether an SNR of the one or more second signals of the second channel 106 is greater than or equal to a predetermined or reference first threshold value.

A criterion for determining whether the noise cancellation, reduction or minimization process is completed may correspond to whether a strength of the first signal transmitted from the first channel 104, among the one or more second signals received or transmitted by the second channel 106, is less than a predetermined or reference second threshold value.

In addition, the operation 550 may include both the determination of the SNR and the determination of the strength of the signal, as described.

When it is determined that the noise cancellation, reduction or minimization process is yet to be completed in operation 550, the output controller 140 may increase a gain of the gain control amplifier 115 to cancel, reduce or minimize the intermodulation noise or the noise signal, in operation 560. And the process then returns to operation 510.

Although not shown in FIG. 5, when the noise cancellation, reduction or minimization process is yet to be completed, various controls for cancelling, reducing or minimizing the intermodulation noise or noise signal may be performed as, for example, by controlling a phase of the inverse signal by the phase converter 114, for example.

Also, for example, the strength of the first signal output from the first channel 104 may be decreased, or a strength of the one or more second signals received or transmitted by the second channel 106 may be increased, for the noise cancellation, reduction or minimization process.

As aforementioned, the process for cancelling, reducing or minimizing the intermodulation noise or noise signal is not limited to being performed by the illustrated configuration of the exemplary communication terminal apparatus 100 of FIG. 1, and may be performed by implementing the illustrated configuration of the exemplary communication terminal apparatus 200 of FIG. 2 or by another equivalent apparatus or equivalent circuit.

In the exemplary methods described with reference to the flowcharts of FIGS. 3 and 4, by measuring the strength of the output first signal of the first channel 104, which is received by the second channel 106, a determination may be made as to whether the low SNR of the second channel 106 results from a factor generated when the output first signal of the first channel 104 is received by the second channel 106.

A response may be performed more promptly, by adjusting the strength of the output first signal of the first channel 104 using a look-up table (LUT), in advance. In this instance, the adjusting of the strength of the output first signal of the first channel 104 may not be performed in advance of the determination of the SNR or level of noise of the noise signal, and may be performed in conjunction with the determination or may be performed in lieu of or independently of the determination, as may be necessary.

FIG. 6 is a flowchart illustrating a process of performing cancellation, reduction or minimization of intermodulation noise according to exemplary embodiments of the present invention.

When it is determined that the measured SNR of the one or more second signals is less than the predetermined or reference first threshold value, in operation 330 of FIG. 3, or when it is determined that the measured level of noise or the noise signal of the first signal is greater than or equal to the predetermined or reference second threshold value, in operation 430 of FIG. 4, the strength of the output first signal of the first channel 104 may be adjusted in operation 610.

In this instance, the process of adjusting the strength of the output first signal of the first channel 104 may be performed by referring to Table 1 based on a level of one or more second output signals of the second channel 106.

TABLE 1

| P | LTE B13 (dBm) |
|---|---|
| P < 18 | 21 |
| 18 ≦ P < 19 | 19 |
| 19 ≦ P < 20 | 16 |
| 20 ≦ P < 21 | 14 |
| 21 ≦ P | 12 |

In Table 1, P denotes a power, such as in decibel-milliwatt (dBm), corresponding to the strength of one or more second signals transmitted from the second channel 106 as, for example, a CDMA 1X voice channel.

In operation 610, the strength of the first signal transmitted from the first channel 104, for example, a strength of a signal transmitted from an LTE data channel, may be adjusted based on the strength of the one or more second signals transmitted from the second channel 106, by referring to Table 1, that is, an LUT. For example, the sensing unit 120 of the control unit 108 may determine the strength of the one or more second signals transmitted from the second channel 106. And the determining unit 130 of the control unit 108 may determine an adjusted strength of the first signal based on the determined strength of the one or more second signals transmitted from the second channel 106, such as by determining a predetermined or reference adjusted strength value for the first signal corresponding to the determined strength of the one or more second signals, such as be referring to Table 1, for example. And the gain control amplifier 115 may adjust the gain of the first signal, such as by adjusting the gain of the feedback signal, to correspond to the predetermined or reference adjusted strength value, such as based on a corresponding control signal from the output controller 140, for example.

In operation 620, it is determined whether the SNR of the one or more second signals of the second channel 106 is improved to be greater than or equal to the predetermined or reference first threshold value. When the SNR is improved, the operation 320 of FIG. 3 and the subsequent operations or the operation 420 of FIG. 4 and the subsequent operations may be performed. When it is determined at operation 620 that the SNR fails to be improved, the operation 340 of FIG. 3 or the operation 440 of FIG. 4 may be performed to improve the SNR or to reduce the level of the noise or noise signal.

Accordingly, the SNR of the one or more second signals of second channel 106 may be improved, by adjusting the strength of the output first signal of the first channel 104 in advance of performing the noise cancellation, reduction or minimization process of the operation 340 or the operation 440.

In addition, as aforementioned, the process for adjusting the strength of the output first signal of the first channel 104 using the LUT is not limited to being performed before the strength of the first signal, output from the first channel 104, received by the second channel 106 is determined. Depending on exemplary embodiments, the aforementioned process for adjusting the strength of the output first signal may be performed after the strength of the first signal, output from the first channel 104 and received by the second channel 106 is determined.

According to another exemplary embodiment of the present invention, the LUT may be implemented as in Table 2.

TABLE 2

| Psum | LTE B13 (dBm) |
|---|---|
| Psum < 24 | 21 |
| 24 ≦ Psum < 25 | 19 |
| 25 ≦ Psum < 26 | 16 |
| 26 ≦ Psum < 27 | 14 |
| 27 ≦ Psum | 12 |

In Table 2, Psum denotes an overall power, such as in decibel-milliwatt (dBm), obtained by adding a strength of one or more second signals transmitted from the second channel 106, for example, the CDMA 1X voice channel, to a strength of the first signal transmitted from the first channel 104 that is input to the second channel 106.

In this instance, in operation 610, the strength of the first signal transmitted from the first channel 104 may be adjusted based on the sum Psum of the strength of the one or more second signals transmitted from the second channel 106, and the strength of the first signal transmitted from the first channel 104 and is received by the second channel 106.

For example, the sensing unit 120 of the control unit 108 may determine the sum of the strength of the first signal transmitted from the first channel 104 and the strength of the one or more second signals transmitted from the second channel 106. And the determining unit 130 of the control unit 108 may determine an adjusted strength value of the first signal based on the sum of the determined strength of the first signal transmitted from the first channel 104 and the one or more second signals transmitted from the second channel 106, such as by determining a predetermined or reference adjusted strength value for the first signal corresponding to the sum of the determined strength of the first signal and the one or more second signals, such as be referring to Table 2, for example. And the gain control amplifier 115 may adjust the gain of the first signal, such as by adjusting the gain of the feedback signal, to correspond to the predetermined or reference adjusted strength value, such as based on a corresponding control signal from the output controller 140, for example.

According to exemplary embodiments of the present invention, the SNR of the one or more second signals of second channel may be improved, by adjusting a level of an output first signal of the first channel in advance of or separately from the process for adjusting the strength of the first signal transmitted from the first channel or the process for adjusting the SNR of the one or more second signals of the second channel.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, deterioration in a quality of a voice communication or loss of a voice signal may be reduced, minimized or prevented without unnecessarily decreasing the strength of an output signal in a data communication.

According to exemplary embodiments of the present invention, high power efficiency may be realized by adaptively cancelling, reducing or minimizing intermodulation noise or a noise signal between antennas while power consumption may be minimized depending on a data output level.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A communication terminal apparatus to perform wireless communication, the apparatus comprising:
a first channel including a first antenna to transmit a first signal at a first frequency;
a second channel including a second antenna to receive or transmit one or more second signals at a frequency other than the first frequency of the first signal; and
a feedback circuit unit to selectively generate a feedback signal to the second channel to reduce a noise signal from the first signal among the one or more second signals received or transmitted through the second channel.

2. The communication terminal apparatus of claim 1, wherein
the feedback circuit unit generates the feedback signal by modulating a phase and adjusting a gain of a segmented first signal.

3. The communication terminal apparatus of claim 2, further comprising:
a coupler to couple the gain adjusted phase modulated feedback signal to the one or more second signals received or transmitted by the second channel to reduce the noise signal received through the second channel.

4. The communication terminal apparatus of claim 1, further comprising:
a control unit to generate a control signal to reduce the noise signal received through the second channel,
wherein the feedback circuit unit adjusts a gain of a phase-modulated feedback signal comprising the feedback signal based on the control signal from the control unit.

5. The communication terminal apparatus of claim 1, further comprising:
a control unit to selectively enable generation of the feedback signal based on a result of a comparison of at least one reference threshold value to at least one of a strength of the first signal, to a level of noise of the noise signal, or to a signal to noise ratio (SNR) of the second signal, and to selectively adjust a gain of a phase modulated feedback signal comprising the feedback signal to correspond to an adjusted strength value for the first signal.

6. The communication terminal apparatus of claim 1, further comprising:
a control unit to generate a control signal to reduce the noise signal received through the second channel and to selectively enable generation of the feedback signal.

7. The communication terminal apparatus of claim 1, further comprising:
a coupler to segment at least a portion of the first signal transmitted by the first channel; and
a filter unit to filter the segmented first signal to generate a filtered frequency signal corresponding to the first signal to reduce the noise signal.

8. The communication terminal apparatus of claim 1, further comprising:
a communication signal processing unit to control processing of the first signal and the one or more second signals by the communication terminal apparatus.

9. The communication terminal apparatus of claim 1, further comprising:
a sensing unit to selectively determine one or more of
a strength of the first signal,
a level of noise of the noise signal,
a signal to noise ratio (SNR) of the one or more second signals, and
an idle state or an active state of the first channel and the second channel relative to transmission or reception of the first signal and the one or more second signals.

10. The communication terminal apparatus of claim 1, further comprising:
a determining unit to one or more of
selectively compare at least one reference threshold value to at least one of a strength of the first signal, a level of noise of the noise signal or a signal to noise ratio (SNR) of the one or more second signals,
selectively determine whether the noise signal has been reduced, and
selectively determine an adjusted strength of the first signal based on one or more of a strength of the transmitted one or more second signals or based on a sum of the strength of the first signal and the strength of the transmitted one or more second signals.

11. The communication terminal apparatus of claim 1, further comprising:
an output controller to selectively adjust a strength of the first signal, selectively adjust a gain of the feedback signal, and selectively enable generation of the feedback signal to reduce the noise signal.

12. The communication terminal apparatus of claim 1, further comprising:
a phase converter to modulate a phase of a filtered frequency signal corresponding to the first signal to generate a phase modulated signal to reduce the noise signal resulting from transmission of the first signal, and
a gain control amplifier to selectively adjust a gain of the phase-modulated signal to generate the feedback signal to reduce the noise signal received through the second channel.

13. The communication terminal apparatus of claim 1, wherein the noise signal comprises intermodulation noise and the feedback signal comprises an inverse phase signal of the first signal.

14. The communication terminal apparatus of claim 1, wherein the first signal comprises a data signal and the one or more second signals comprise a voice signal.

15. A method for reducing a noise signal generated by a communication terminal apparatus for performing wireless communication, the method comprising:
transmitting over a first channel of the communication terminal apparatus a first signal at a first frequency;
receiving or transmitting over a second channel of the communication terminal apparatus one or more second signals at a frequency other than the first frequency of the first signal; and
selectively generating a feedback signal to reduce a noise signal from the first signal among the one or more second signals received or transmitted through the second channel.

16. The method of claim 15, wherein selectively generating the feedback signal further comprises:
modulating a phase of a segmented first signal; and
adjusting a gain of the segmented first signal.

17. The method of 16, further comprising:
coupling the gain adjusted phase modulated feedback signal to the one or more second signals received or transmitted by the second channel to reduce the noise signal.

18. The method of claim 15, further comprising:
selectively determining an adjusted strength of the first signal based on one or more of a strength of the transmitted one or more second signals or based on a sum of a strength of the first signal and a strength of the transmitted one or more second signals; and
selectively adjusting the strength of the first signal based on the result of the determination.

19. The method of claim 15, further comprising:
generating a control signal to selectively adjust a gain of the feedback signal to reduce the noise signal.

20. The method of claim 15, further comprising:
selectively adjusting a gain of the feedback signal to correspond to an adjusted strength value for the first signal.

21. The method of claim 15, wherein the first signal comprises a data signal and the one or more second signals comprise a voice signal.

22. The method of claim 15, wherein the noise signal comprises intermodulation noise and the feedback signal comprises an inverse phase signal of the first signal.

23. A non-transitory computer-readable media, the media including program instructions that, when executed, implement a method embodied by a communication terminal apparatus for reducing a noise signal generated for performing wireless communication, the method comprising:
transmitting over a first channel of the communication terminal apparatus a first signal at a first frequency;
receiving or transmitting over a second channel of the communication terminal apparatus one or more second signals at a frequency other than the first frequency of the first signal; and
selectively generating a feedback signal to reduce a noise signal from the first signal among the one or more second signals received or transmitted through the second channel.

24. The non-transitory computer readable media of claim 23, wherein the method further comprises:
generating a control signal to selectively adjust a gain of the feedback signal to reduce the noise signal.

25. The non-transitory computer readable media of claim 23, wherein selectively generating the feedback signal further comprises:
modulating a phase of a segmented first signal, and
adjusting a gain of the segmented first signal.
